(19) United States
(12) Patent Application Publication
(10) Pub. No.: US 2010/0004774 A1
(43) Pub. Date: Jan. 7, 2010

(54) System For Real-Time Surveillance Of Production Facility And Environmental Conditions

(75) Inventors: Pi-Chen Chen, Taipei City (TW); Mei-Lung Lu, Taipei County (TW); Ching-Chih Huang, Taipei County (TW); Ping-Tang Yu, Taipei County (TW)

Correspondence Address: WPAT, PC;INTELLECTUAL PROPERTY ATTORNEYS, 2030 MAIN STREET, SUITE 1300, IRVINE, CA, 92614, US

(73) Assignees: Yao-Ming Yang, Taipei County (TW); Kuan-Yang Chen, Taipei County (TW); LIANZHUN TECHNOLOGY CORPORATION, Taipei County (TW)

(21) Appl. No.: 12/168,562

(22) Filed: Jul. 7, 2008

(51) Int. Cl. G06F 19/00

(52) U.S. Cl. 700/108

(57) ABSTRACT

A real-time surveillance system of the present invention comprises a plurality of machine surveillance controllers for surveying a specific production line, the operation real time data of the production lines are collected and are transmitted via a communication interface to a server for showing on a surveillance display, so that a remote manager can effectively manage the operation state of production lines in order to achieve the purposes of reducing labor and manufacturing costs, upgrading production efficiency and improving product quality. The machine surveillance controllers are serially connected to simplify the communication cable connection in the production lines in order to facilitate the maintenance of production facility.

### FIELD OF THE INVENTION

The present invention relates to a system for surveying a production site, and more particularly to a system for real-time surveillance of production facility and environmental conditions.

### BACKGROUND OF THE INVENTION

In early-stage plant process, experienced operators are relied on to survey production lines through manual examination and visual inspection. Such manual examination and visual inspection are not ideal due to low accuracy thereof. With the constantly increasing demands for upgraded product quality as well as the largely increased labor cost, the traditional manual and visual surveillance of production lines is no longer suitable for nowadays requirements. On the other hand, in recent years, due to the upgraded performance and lowered price thereof, computers have been widely applied in plant automation systems to effectively achieve multiple benefits, including reduced labor and manufacturing costs, increased efficiency, and improved product quality.

The control and surveillance of production lines are two important parts in automated plant process that provide the prerequisite production information as basis for machine and operator management as well as productivity analyses. However, with the highly automated plant process, communication cable connection between automated machines becomes so complicate that it is difficult to troubleshoot when the machines are failed. Moreover, with the increasing growth of automated plant scale, more and more complicated surveillance apparatus are required for controlling and supervising the production lines, leading to difficulties in integrating the production information provided by the large number of surveillance apparatus.

It is therefore tried by the inventor to develop a real-time surveillance system to enable convenient maintenance and troubleshooting of automated machines and assist plant managers in understanding the machine operation state in real time and fully controlling information about production lines and machine operation.

### SUMMARY OF THE INVENTION

A primary object of the present invention is to provide a system for real-time surveillance of production facility and environmental conditions, which operation state and operation data from multiple production lines may be collected in real time by controllers provided on the production lines and transmitted via a communication interface to a server for showing on a surveillance computer display, so that a remote manager may effectively know and control the operation state of the production lines to achieve the purpose of reducing labor and manufacturing costs, upgrading production efficiency, and improving product quality.

Another object of the present invention is to provide a system for real-time surveillance of production facility and environmental conditions, in which a plurality of machine surveillance controllers are serially connected to simplify the communication cable connection among production lines and facilitate the maintenance of the production lines.

In order to achieve the above and other objects, the system of real-time surveillance for production facility and environmental conditions according to a preferable example of the present invention, includes: a plurality of machine surveillance controllers, that are grouped into several machine surveillance groups and each of the machine surveillance controllers is used to survey different conditions of a specific production line, which includes the conditions of machine operation, production targets, and production environment, wherein each of the machine surveillance groups is provided with a surveillance module, that comprises at least a scan unit for acquiring data related to various settings of the production lines; a detection unit having a detecting device that is connected thereto for acquiring environmental detection data; a central processing unit (CPU) receiving data from the scan unit and the detection unit, in which the data is outputted to a surveillance data; and a controller area network bus (CANBUS) unit receiving the surveillance data outputted by the CPU and then sending out the surveillance data; a surveillance host controller, that is provided with a host module for collecting the surveillance data which are sent out by the machine surveillance groups; a network hub, that is connected to the surveillance host controller, and the surveillance data collected by the surveillance host controller are sent out through a network; and a server, that is used to receive the surveillance data sent out by the network hub, so that a remote manager is utilized to obtain the surveillance data of the machine operation, the production targets, and the production environment in accordance with different production lines in order to achieve the purpose of real-time surveillance.

To enable simplified communication cable connection in the production lines, the machine surveillance controllers within the same one machine surveillance group are connected to one another by using a physical line to serially connect to the CANBUS unit in each of the machine surveillance controllers, and the physical line is connected at one end of the surveillance host controller. With the CANBUS unit, even if any one of the serially connected machine surveillance controllers is failed, the remaining machine surveillance controllers may still send their respective surveillance data to the surveillance host controller. Meanwhile, the problem of complicated cable connection due to the provision of a communication cable between each of the machine surveillance controllers and the surveillance host controller is eliminated.

The real-time surveillance system of the present invention provides the function of data collection, so that machine operation data may be provided for reference in machine maintenance to enable preventive maintenance and reduced machine failure rate. Through a communication interface, data related to the production lines and detected by the machine surveillance controllers, including the machine operation state, production targets, and production environmental conditions on the production lines, may be transmitted via a network to the server in real time.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a system chart of a system for real-time surveillance of production facility and environmental conditions according to the present invention;

FIG. 2 is a function block diagram of a surveillance module included in the system of the present invention; and

FIG. 3 is a function block diagram of a host module included in the system of the present invention.

### DETAILED DESCRIPTION OF THE PREFERRED EMBODIMENTS

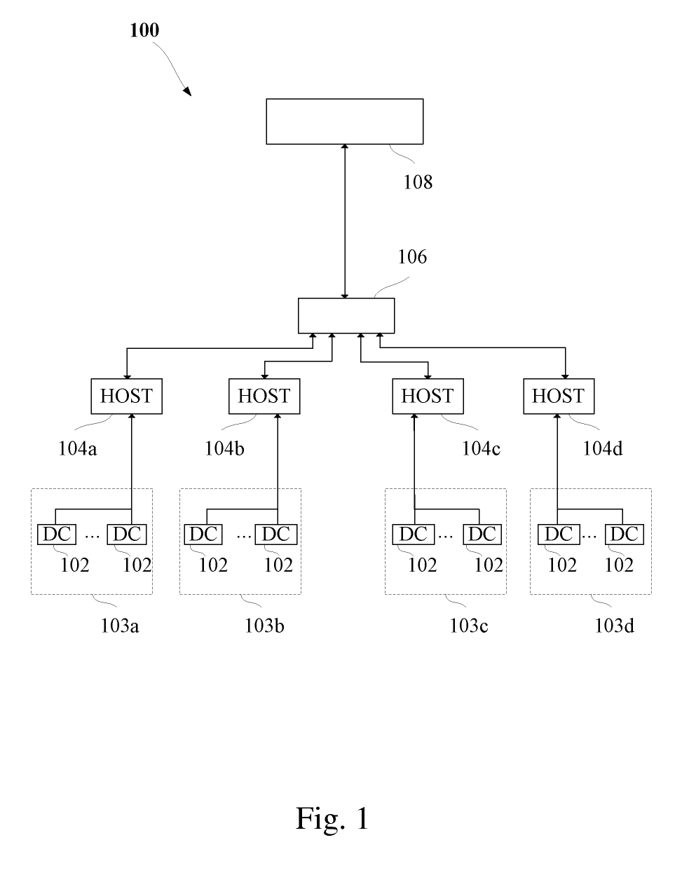

Please refer to FIG. 1 that is a system chart of a system for real-time surveillance of production facility and environmental conditions according to the present invention. For the purpose of conciseness, the system of the present invention will also be briefly referred to as the real-time surveillance system and is generally denoted by a reference numeral 100 herein. As shown, the real-time surveillance system 100 is a distributed control system (DCS) including a machine surveillance controller (DCS-DC) 102 located at each of a plurality of machines or production lines, a plurality of surveillance host controllers (DCS-HOST) 104a to 104d, a network hub 106, and a server 108. The machine surveillance controllers 102 are grouped into several machine surveillance groups 103a to 103d, each of which is independently connected to one of the surveillance host controllers 104a to 104d. It is understood the number of the machine surveillance groups 103a to 103d and of the surveillance hosts 104a to 104d shown in FIG. 1 is only for illustration and not intended to limit the present invention. As a matter of fact, the machine surveillance groups and the surveillance hosts may be of any number so long as they are substantially available.

As shown in FIG. 1, each of the machine surveillance controllers 102 is used to survey the machine operation, production targets, and environmental conditions in a specific production line, and send out related surveillance data. All of the machine surveillance controllers 102 within the same one machine surveillance group, for example, machine surveillance group 103a, are serially connected via a physical line, which is connected at an end of the surveillance host controller 104a. Due to the machine surveillance controllers 102 are serially connected to one another via one single line, the connection between the machines is largely simplified to facilitate maintenance and troubleshooting conveniently. Then, the surveillance host controllers 104a to 104d respectively collect the surveillance data from the corresponding machine surveillance groups 103a to 103d, and are independently connected to the network hub 106 to pass the collected surveillance data via a network line. Then, the network hub 106 transmits the received surveillance data via Internet, a local area network (LAN), or an Intranet to the server 108 at a remote location. Thus, the operation conditions and operation data of machines on the production lines may be displayed on a surveillance computer at the server, enabling a remote manager to know the operation conditions of machines on the production lines in real time.

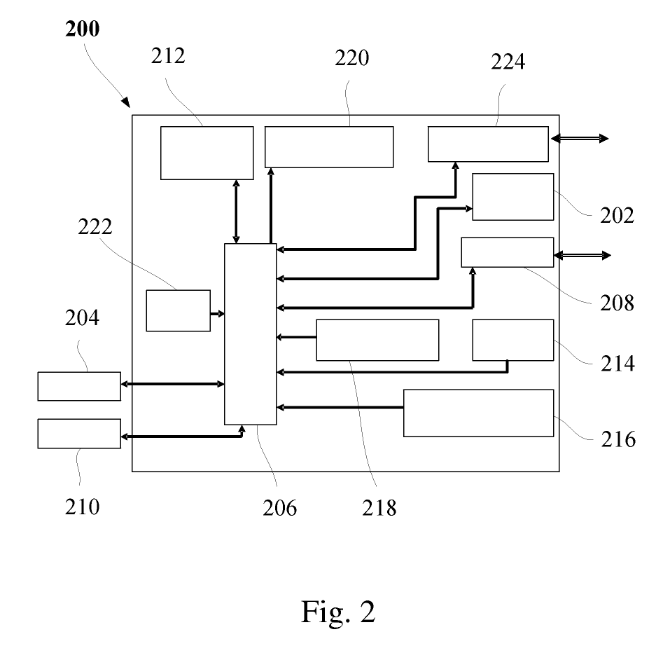

Please refer to FIG. 2 that is a function block diagram of a surveillance module 200 provided for each of the machine surveillance groups 103a to 103d. As shown, the surveillance module 200 includes a scan unit 202, a detection unit 204, a central processing unit (CPU) 206, and a controller area network bus (CANBUS) unit 208.

The scan unit 202 may be a barcode module or a QR (Quick Response) code module (a two-dimensional barcode) for acquiring related production line data, such as the settings, personnel management, and material management for each production line.

The detection unit 204 has a detecting device connected thereto for getting environmental detection data, such as sensing production facility conditions and receiving production targets, material conditions, and operating environmental conditions. The detecting device may be any data sensor or signal-generating switch, such as a sensor switch, an infrared sensor, a magnetic reed switch, a temperature and humidity sensor, or a pressure sensor.

The CPU 206 is an ARM-based CPU adopting the ARM architecture widely used in a number of embedded designs, and has a controller for controlling the overall system of the present invention, and is able to communicate with the server 108 via a communication interface, such as a CANBUS, to execute all command actions. The CPU 206 receives data from the scan unit 202 and the detection unit 204, and outputs a surveillance data.

In FIG. 2, the CANBUS unit 208 uses a CANBUS communication interface to serially connect with other machine surveillance controllers 102 and a corresponding one of the surveillance host controllers 104a to 104d, then receiving the surveillance data from the CPU 206 and sending out the surveillance data to the corresponding surveillance host controller. The CANBUS unit 208 has a transmission rate of 1 MB/s within a transmission distance of 40 meters, and a transmission rate of 5 KB/s within a transmission distance of 10 kilometers, and is superior to the conventional transmission interface RS 422/485 which is often adopted by general industries and has no more than 256 control nodes. Wherein, the highest possible number of the machine surveillance controllers 102 that can be serially connected to the CANBUS unit 208 depends on the way for editing the CANBUS bit control, and may be up to 2²⁹. However, in the CANBUS of version 2.0B, the controller may have a mark length of 11 bits or 20 bits. The CANBUS unit 208 has an input and an output (not shown), enabling the communication cable for the serial connection of the machine surveillance controllers 102 to transmit data independently without being affected by the machine surveillance controllers 102. Therefore, even if any one of the serially connected machine surveillance controllers 102 is failed, the remaining machine surveillance controllers 102 may still send respective surveillance data to the corresponding surveillance host controller.

As shown in FIG. 2, the CPU 206 is further connected to at least one peripheral 210, so as to perform automatic parameter adjustment for the peripheral 210 with respect to the acquired surveillance data. For example, when the detection unit 204 detects an overly high temperature from one machine, a heat dissipation device as a peripheral of the overheated machine is automatically enhanced in its performance of heat dissipation to achieve the automatic adjustment function.

The surveillance module 200 further includes a memory access unit 212, an input keypad unit 214, a production input unit 216, a warning output unit 218, a display unit 220, a power supply module 222, and a wireless transmission unit 224.

The memory access unit 212 is an electrically-erasable programmable read-only memory (EEPROM) for storing data that has been processed by the CPU 206 but not yet been transmitted from the CPU 206, so as to ensure the data is not lost in a power interruption.

The input keypad unit 214 is an interface for inputting machine settings and operation settings, such as machine serial number, machine model number, allowable error rate, altered password, etc. The input keypad unit 214 may also be used to set work shift, operators, customer name, material batch number, mold cavity quantity, etc.

The production input unit 216 is used to set parameters related to the production targets and check settings for the machine surveillance controllers 102.

The warning output unit 218 is able to indicate the current state of the machine surveillance controllers 102 in real time and show a warning message by a light emitting module.

The display unit 220 is used to display the above-mentioned information in the form of text and illustration.

The power supply module 222 further includes a backup power module (not shown).

According to FIG. 2, the wireless transmission unit 224 may be used to replace the CANBUS unit 208 for wireless connection between the machine surveillance controllers 102 in the same one machine surveillance group, and transmit the surveillance data from the CPU 206 to the surveillance host controller belonged to the machine surveillance group.

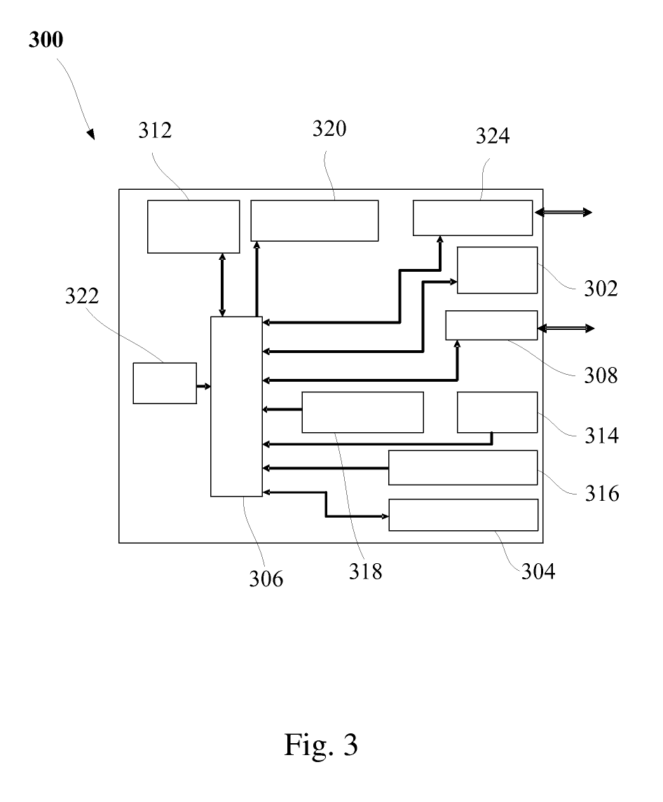

FIG. 3 is a function block diagram of a host module 300 provided for each of the surveillance host controllers 104a to 104d. As shown, the host module 300 is generally structurally similar to the surveillance module 200, except that the detection unit and the peripheral are omitted and an Ethernet unit is added. More specifically, the host module 300 includes a scan unit 302, an Ethernet unit 304, a central processing unit (CPU) 306, a CANBUS unit 308, a memory access unit 312, an input keypad unit 314, a production input unit 316, a warning output unit 318, a display unit 320, a power supply module 322, and a wireless transmission unit 324.

With the host module 300, the surveillance host controller is able to collect the surveillance data sent out by the corresponding machine surveillance group. The surveillance data may be collected via the CANBUS unit 308 by a physical line or in a manner of wireless transmission via the wireless transmission unit 324 and received by the CPU 306. Then, the Ethernet unit 304 gets the surveillance data from the CPU 306 and transmits it to the network hub 106.

In conclusion, with the system for real-time surveillance of production facility and environmental conditions according to the present invention, the remote manager is able to effectively manage the state of production lines and review the real time data reports in the production; and the surveillance modules 200 and the host modules 300 allows the surveillance controllers in a more stable condition in order to maintain the productive facilities effectively and easily.

The present invention is described with a preferred embodiment thereof and it is understood that many changes and modifications in the described embodiment can be carried out without departing from the scope and the spirit of the invention that is intended to be limited only by the appended claims.

What is claimed is:

1. A system for real-time surveillance of production facility and environmental conditions, comprising:
a plurality of machine surveillance controllers, that are grouped into several machine surveillance groups and each of the machine surveillance controllers is used to survey different conditions of a specific production line, which includes the conditions of machine operation, production targets, and production environment, wherein each of the machine surveillance groups is provided with a surveillance module, that comprises at least:
a scan unit for acquiring data related to various settings of the production lines;
a detection unit having a detecting device that is connected thereto for acquiring environmental detection data;
a first central processing unit (CPU) receiving data from the scan unit and the detection unit, in which the data is outputted to a surveillance data; and
a first controller area network bus (CANBUS) unit receiving the surveillance data outputted by the first CPU and then sending out the surveillance data;
a surveillance host controller, that is provided with a host module for collecting the surveillance data which are sent out by the machine surveillance groups;
a network hub, that is connected to the surveillance host controller, and the surveillance data collected by the surveillance host controller are sent out through a network; and
a server, that is used to receive the surveillance data sent out by the network hub, so that a remote manager is utilized to obtain the surveillance data of the machine operation, the production targets, and the production environment in accordance with different production lines in order to achieve the purpose of real-time surveillance.

2. The system for real-time surveillance as claimed in claim 1, wherein the data acquired by the scan unit include production settings, production human resource management data and production material management data.

3. The system for real-time surveillance as claimed in claim 1, wherein the detection unit is selected from the group consisting of a sensor switch, an infrared sensor, a magnetic reed switch, a temperature and humidity sensor, and a pressure sensor.

4. The system for real-time surveillance as claimed in claim 1, wherein the first CPU is connected to at least one peripheral, to perform automatic parameter adjustment for the peripheral with respect to the surveillance data acquired from the scan unit and the detection unit.

5. The system for real-time surveillance as claimed in claim 1, wherein the machine surveillance controllers within the same one machine surveillance group are serially connected by a physical line, and those first CANBUS units within the machine surveillance controllers are also connected in serial by the physical line, wherein the physical line is connected to one end of the surveillance host controller belonged to the corresponding machine surveillance group.

6. The system for real-time surveillance as claimed in claim 1, wherein the surveillance module further includes a first wireless transmission unit, which may replace the first CANBUS unit for wireless connection to the machine surveillance controllers within the same one machine surveillance group, and sends the surveillance data to the surveillance host controller.

7. The system for real-time surveillance as claimed in claim 1, wherein the surveillance module further includes:
a memory access unit for storing data that has been processed by the first CPU but are not yet been sent out from the first CPU;
an input keypad unit for serving as an interface to input machine settings and operation settings;
a production input unit for setting parameters related to the production targets, and checking the settings of the machine surveillance controller; and
a warning output unit acting as an indicator to show a real time state of the machine surveillance controller and a warning message sent out by a light emitting module.

8. The system for real-time surveillance as claimed in claim 1, wherein the host module includes at least:
a second CANBUS unit for collecting the surveillance data sent out from the machine surveillance group;
a second CPU for receiving the surveillance data collected by the second CANBUS unit; and
an Ethernet unit for retrieving the surveillance data from the second CPU and transmitting the retrieved surveillance data to the network hub.

9. The system for real-time surveillance as claimed in claim 1, wherein the host module further includes a second wireless transmission unit, in which replaces the second CANBUS unit for wireless connection to the machine surveillance controllers within the same one machine surveillance group and collects the surveillance data sent out by the machine surveillance group.

10. A system for real-time surveillance of production facility and environmental conditions, comprising:
a plurality of machine surveillance controllers, that are grouped into several machine surveillance groups, and each of the machine surveillance controllers is used to survey various conditions of a specific production line, which includes the conditions of machine operation, production targets and production environment, wherein each of the machine surveillance groups is provided with a surveillance module, that includes at least:
a scan unit for acquiring data related to different settings of the production lines;
a detection unit having a detecting device that is connected thereto for acquiring environmental detection data;
a first central processing unit (CPU) for receiving data from the scan unit and the detection unit, and outputting a surveillance data; and
a first controller area network bus (CANBUS) unit for receiving the surveillance data outputted by the first CPU, and then sending out the surveillance data;
a plurality of surveillance host controllers, that is respectively connected to one of the machine surveillance groups and provided with a host module for collecting the surveillance data sent out by one corresponding machine surveillance group;
a network hub, that is connected to the surveillance host controllers, wherein the surveillance host controllers are respectively connected to one of the machine surveillance groups and send out the surveillance data collected by the surveillance host controllers; and
a server, that is used to receive the surveillance data sent out by the network hub, so that a remote manager is utilized to obtain the surveillance data related to the machine operation, the production targets, and the production environment in accordance with different production lines in order to achieve the purpose of real-time surveillance.

11. The system for real-time surveillance as claimed in claim 10, wherein the data acquired by the scan unit include production settings, production human resource management data and production material management data.

12. The system for real-time surveillance as claimed in claim 10, wherein the detection unit is selected from the group consisting of a sensor switch, an infrared sensor, a magnetic reed switch, a temperature and humidity sensor, and a pressure sensor.

13. The system for real-time surveillance as claimed in claim 10, wherein the first CPU is connected to at least one peripheral to perform automatic parameter adjustment for the peripheral with respect to the surveillance data acquired from the scan unit and the detection unit.

14. The system for real-time surveillance as claimed in claim 10, wherein the machine surveillance controllers within the same one machine surveillance group are serially connected by a physical line, and those first CANBUS units within the machine surveillance controllers are also connected in serial by the physical line, wherein the physical line is connected to one end of the surveillance host controller belonged to the corresponding machine surveillance group.

15. The system for real-time surveillance as claimed in claim 10, wherein the surveillance module further includes a first wireless transmission unit, which replaces the first CANBUS unit for wireless connection to the machine surveillance controllers within the same one machine surveillance group, and sending the surveillance data to the surveillance host controller corresponding to that machine surveillance group.

16. The system for real-time surveillance as claimed in claim 10, wherein the surveillance module further includes:
a memory access unit for storing data that has been processed by the first CPU but are not yet sent out from the first CPU;
an input keypad unit for serving as an interface to input machine settings and operation settings;
a production input unit for setting parameters related to the production targets, and checking the settings of the machine surveillance controller; and
a warning output unit for acting as an indicator to show a real time state of the machine surveillance controller and a warning message sent out by a light emitting module.

17. The system for real-time surveillance as claimed in claim 10, wherein the host module includes at least:
a second CANBUS unit for collecting the surveillance data sent out from the corresponding machine surveillance group;
a second CPU for receiving the surveillance data collected by the second CANBUS unit; and
an Ethernet unit for retrieving the surveillance data from the second CPU and transmitting the retrieved surveillance data to the network hub.

18. The system for real-time surveillance as claimed in claim 10, wherein the host module further includes a second wireless transmission unit, which replaces the second CANBUS unit for wireless connection to the machine surveillance controllers within the same one machine surveillance group and collects the surveillance data sent out by that machine surveillance group.
